(19) United States
(12) Patent Application Publication
(10) Pub. No.: US 2020/0211376 A1
(43) Pub. Date: Jul. 2, 2020

(54) Systems and Methods to Enable a Transportation Network with Artificial Intelligence for Connected and Autonomous Vehicles

(71) Applicant: Pujan Roka, (US)

(72) Inventor: Pujan Roka, Alpharetta, GA (US)

(73) Assignee: Pujan Roka, Alpharetta, GA (US)

(21) Appl. No.: 16/727,650

(22) Filed: Dec. 26, 2019

Related U.S. Application Data
(60) Provisional application No. 62/787,161, filed on Dec. 31, 2018.

(51) Int. Cl. G08G 1/01; G06K 9/00; G01S 17/89; G06N 20/00; G06F 9/54; H04W 4/44

(52) U.S. Cl. CPC G08G 1/0145; G08G 1/0141; G08G 1/0129; H04W 4/44; G01S 17/89; G06N 20/00; G06F 9/541; G06K 9/00805

(57) ABSTRACT

A transportation network system that provides machine intelligence relating to at least one road and a periphery of the at least one road includes: a plurality of sensors for identifying static and moving objects on the at least one road, spatial dimensions of the objects with respect to the at least one road, and an environment around the objects, the sensors being configured to translate and store the identified objects, spatial dimensions, and environment as machine readable data; a plurality of communication devices and transmitters for transmitting the machine readable data between the plurality of sensors and to remote computer cloud systems; and a computer cloud system for receiving the machine readable data from the plurality of communication devices and to store the machine readable data, the computer cloud creating machine intelligence based on the machine readable data, the computer cloud system including an application programming interface.

### CROSS-REFERENCE TO PRIOR APPLICATION

Priority is claimed to U.S. Provisional Patent Application No. 62/787,161, filed on Dec. 31, 2018, the entire disclosure of which is incorporated by reference herein.

### BACKGROUND

Connected and autonomous vehicles have been tested successfully in recent years and they have been deployed in several locations around the world. Such vehicles have been proven to navigate from one location to the next by using GPS navigation and LiDAR sensors that help them to identify and respond to the environment ahead of them as they move forward without human assistance. However, such vehicles have limited visibility of the road and environmental conditions beyond the limit of the sensors they use to detect objects in front of them. The range of visibility provided by LiDAR sensors, which are used commonly in connected and autonomous vehicles, are limited by the power and range of their proximity detection system. If there is a physical obstruction of the view of the road ahead of them, such sensors are not able to detect road or environmental conditions. For example, if a tree falls suddenly in front of several vehicles ahead of the autonomous vehicle, then the LiDAR sensor will not be able to identify the road hazard until the vehicle is in front of the hazard. If a pothole appears suddenly on the road, the LiDAR sensor may not be able to caution the vehicle of the hazard ahead that needs to be avoided immediately. If there is a sudden change in vertical clearance of an overpass on the road, which may result from a sudden buckling, collapse, or damage of the structure of that overpass, then GPS application will not be able to detect such a sudden change. Furthermore, traffic density and movement patterns of the road ahead is not available in detail using GPS applications. A GPS application may provide traffic condition in color coded as red, yellow, and green, which could mean different things depending on traffic situation. Such indicators will not identify traffic pattern in terms of direction of movement of the traffic.

Moreover, with the advent of autonomous aerial vehicles or drones, there must be a communication network infrastructure, especially in residential areas, to aide such vehicles to navigate from one location to the other and by navigating through elevated objects like trees and light poles. Navigation sensors can be installed on road infrastructure like traffic poles or light poles to guide aerial vehicles navigate from one location to the other. This is very similar to how VHF Omni-directional Range or VORs on the ground are used to help airplanes navigate in the sky. In other words, sensors described in this application, which are mounted on traffic lights, light poles, or other locations of the roads, can be used as a VOR equivalent for aerial vehicles that may fly within a few hundred feet from the ground.

Machine intelligence of roads and their environments can also benefits entities other than connected vehicles and they are municipalities and enterprises that benefit from such intelligence. Sensors that detect traffic condition can be used by municipalities to make intelligent decision to maintain or improve road conditions and its infrastructure. Enterprises can also use such machine intelligence to deploy autonomous surface or aerial delivery vehicles.

### SUMMARY

In an embodiment, the present invention provides a transportation network system that provides machine intelligence relating to at least one road and a periphery of the at least one road, the system comprising: a plurality of sensors configured to identify static and moving objects on the at least one road, spatial dimensions of the objects with respect to the at least one road, and an environment around the objects, the sensors being configured to translate and store the identified objects, spatial dimensions, and environment as machine readable data; a plurality of communication devices and transmitters configured transmit the machine readable data between the plurality of sensors and to remote computer cloud systems; and a computer cloud system configured to receive the machine readable data from the plurality of communication devices and to store the machine readable data, the computer cloud system being configured to create machine intelligence based on the machine readable data, the computer cloud system comprising an application programming interface configured to share the machine readable data and the machine intelligence to at least one of a connected vehicle, a municipality, or an enterprise.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1. Illustrates the overall information architecture of this disclosure and depicts categories of components that interact with each other to provide artificial intelligence of roads and environmental conditions to connected and autonomous vehicles, municipalities, and enterprises. These categories include Computing Environment 100, Network Systems 140, Enterprise System 170, Connected Vehicle System 160, Network Monitoring System 150 and Municipality System 180. Each of these categories encapsulate several sub-components that interact with each other, which are described in the ‘Detail Description’ section.

FIG. 2. This diagram depicts high level architecture of how sensors 110 can be mounted on roads or landmarks on roads, such as traffic poles and light poles and, that is, to detect road, surface above the road, areas below the roads, traffic, and environmental conditions in real or near real time. This architecture will also entail digital mapping of the road in three dimensions, so vehicles 114, 115 can receive three dimensional data of stationary structures and objects on the road and also real time data when there's any change in those structures and objects, such as weather situations that may damage or alter their conditions. Digital imaging of the road could also include data for areas above the road in the space that could be used by connected and autonomous aerial vehicles like delivery drones. This type of aerial data may allow such aerial vehicles to pass through elevated objects, such as tree branches, utility wires and poles. Furthermore, this architecture also includes three dimensional digital mapping of the area underneath the ground surface using technology like Ground Penetrating Radar (GPR). Underground imaging or mapping may be helpful to connected, autonomous and robotic utility vehicles that, in the future, may undertake various utility maintenance work without human intervention.

FIG. 3. This diagram depicts a high level architecture of the Light Detection and Ranging (LiDAR) sensor that detects stationary and mobile objects and structures on the road and above the road in the vicinity of that sensor. LiDAR sensors shoot light waves in many directions and detect objects by calculating the time taken for the light waves to hit the object or surface and reflect back to the sensor.

FIG. 4. This diagram depicts a high level architecture of the Camera Sensor System that uses image detection, image processing, and computer vision to detect stationary and mobile objects and structures on the road and above the road in the vicinity of that sensor. Video cameras that are integrated with Computer Vision technology can detect stationary and mobile objects and living beings. Computer Vision uses machine learning algorithm to identify the context for data sets of integer values that represent intensities across color spectrum for a given image or image frames.

FIG. 5. This diagram depicts one time or recurring mapping in three-dimensional imaging of the road surface 125, areas, objects and landmarks underneath the road surface 124 and the vertical space above the surface of the road 123. Imaging of the areas above the surface of the roads can be accomplished by using Light Detection and Ranging or LiDAR imaging sensors. Imaging of the areas underneath the surface of the roads can be accomplished by using Ground Penetrating Radar or GPR imaging sensors. Imaging data can be stored in binary digits or formats that be read by machines and computer systems.

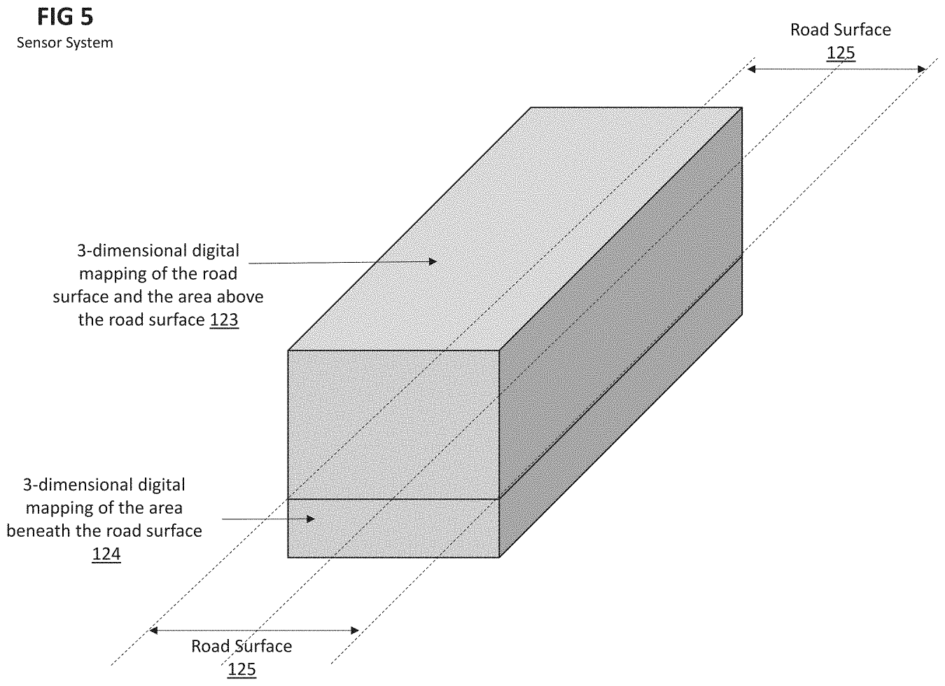

FIG. 6. This diagram depicts the main component of this disclosure—the Artificial Intelligence Engine that receives real time data inputs from sensors, imaging database, and other sources of geospatial data, and combines those inputs with historical and other contextual information to create machine intelligence of the roads and the areas around the road, above the road, and below the road. The output data is provided to remote objects, such as connected vehicles, municipalities, enterprises and other third-party systems over wired or wireless communication systems. The Artificial Intelligence Engine is hosted in the Cloud system and its data is made available to external systems using Application Programming Interfaces or APIs.

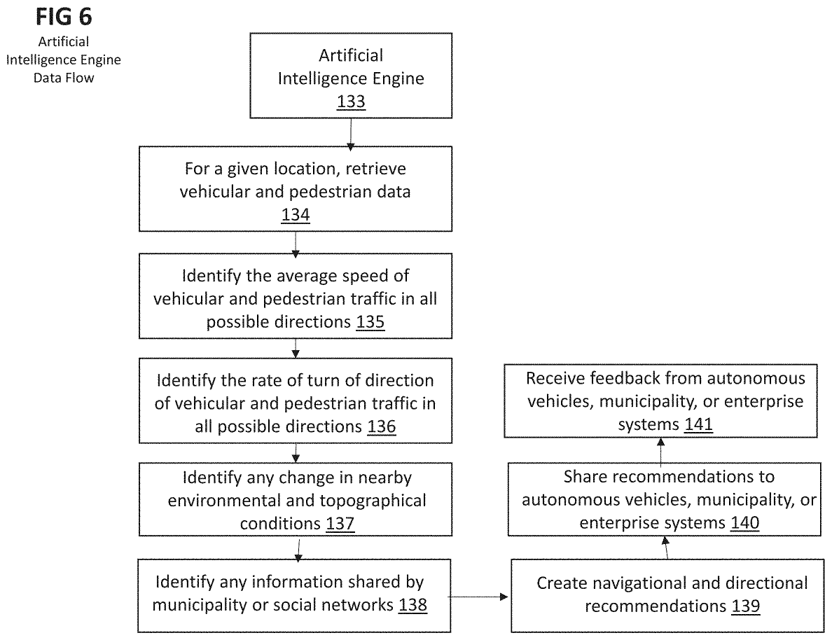

FIG. 7. This diagram illustrates the Connected Vehicle System that is used by connected and autonomous vehicles to identify its location and the path of navigation and to use the data and information it receives from the Artificial Intelligence Engine. The Intelligent Navigation System may also receive inputs from the operator of the vehicle and the operator could be located inside the vehicle or located remotely. This system may relay the information it receives from the Artificial Intelligence Engine to the Vehicle Control System 166, or it may also process that information further before sending it to the Vehicle Control System. For example, the Artificial Intelligence Engine may inform the connected vehicle to turn around to avoid traffic congestion, but the Vehicle Control System may reject the recommendation considering the fact that the destination is only a few yards away from the location of traffic congestion.

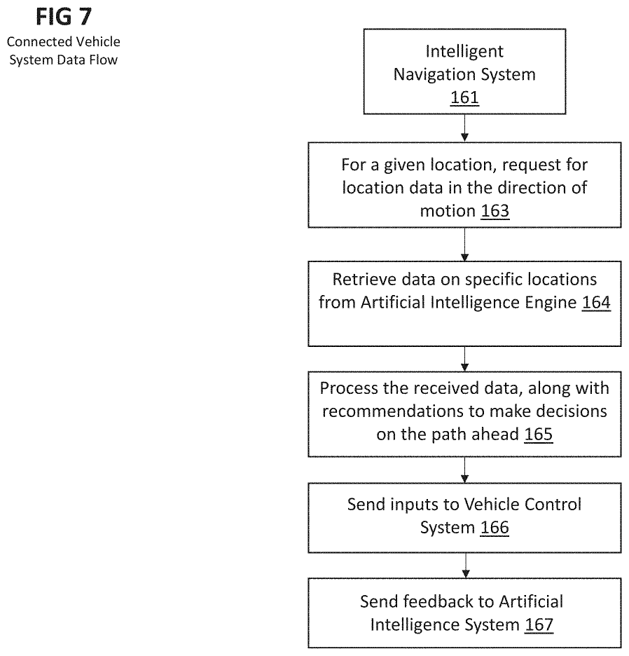

FIG. 8. The Enterprise System 170 also receives information and recommendations from the Artificial Intelligence Engine. The view of this information may be controlled by access control rules defined by the Enterprise System. Members of the Enterprise System will be allowed to consume the information passively. In certain circumstances, members of the Enterprise System will be able to provide feedback to the Artificial Intelligence Engine or the Municipality System; In the latter case, feedback to the Artificial Intelligence Engine will have to be routed through the Municipality System due to security reasons. For example, an Enterprise System monitoring the status of a certain area of the transportation network may decide to pause the availability of the Artificial Intelligence Engine data to be received by a certain connected vehicle type administered by that Enterprise System, which could result from scenarios such as a software defect in the Vehicle Control System of that respective vehicle.

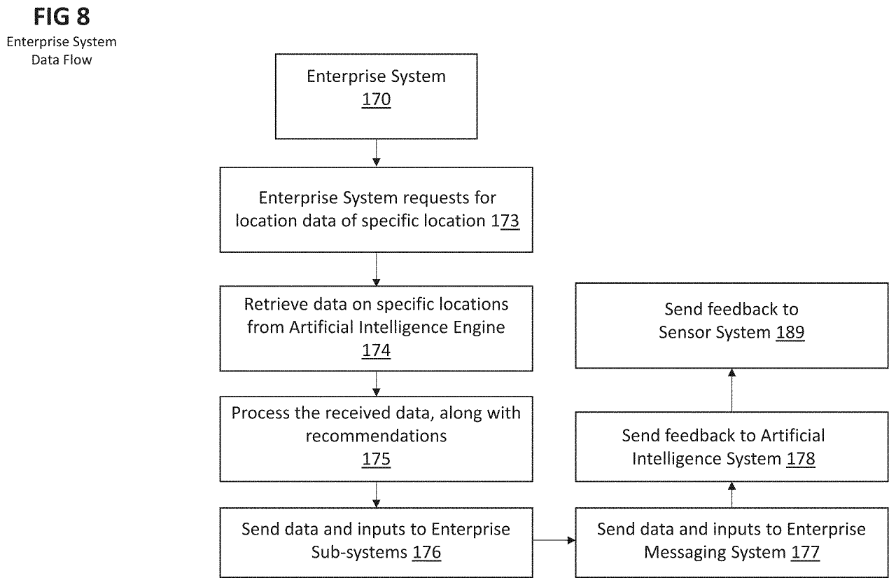

FIG. 9. The Municipality System 180 receives information and recommendations from the Artificial Intelligence Engine and it may consume that information passively by allowing members of municipality to observe that information. It may also send feedback to the Artificial Intelligence Engine, such as in the scenario when the municipality decides to make decisions on certain locations or areas of the road and its surroundings based on certain road or environmental condition, such as closing a sloppy passage of a road during winter weather. If there is a road hazard near a certain location or sensor, the municipality may decide to block that part of the road, so it can inform the respective sensors that the road has been closed due to given reasons. The Municipality System may also delegate access control to the information from the Artificial Intelligence System to be made available to certain Vehicle Control System and Enterprise System. In other words, if a Vehicle Control System in a vehicle reports the road being slippery, then it could send that hazard information to the Artificial Intelligence Engine that, in turn, notifies the Municipality System. The administrator of the Municipality System may delegate the automation of that hazard information to allow the Artificial Intelligence Engine to relay to Vehicle Control System to avoid that stretch of the road altogether.

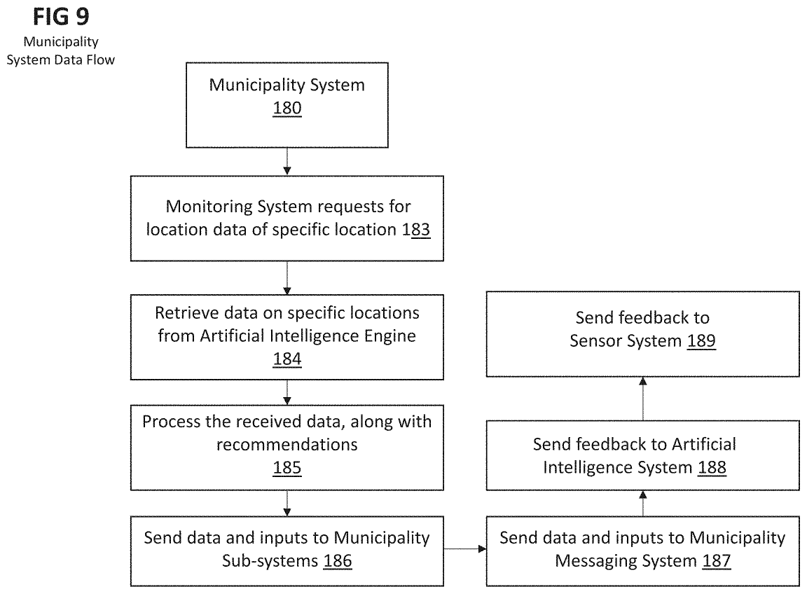

### DETAILED DESCRIPTION

Connected vehicles are not new to the transportation industry. Various types of connected vehicles are already available in the market. Some connected vehicles come with embedded wireless Internet connection to provide on-board information and entertainment, often referred to as “infotainment.” Other types of connected vehicles connect to remote Internet systems using wireless networks to assist drivers with navigational data, along with infotainment. Some connected vehicles are fully autonomous; They also connect to remote Internet systems using wireless networks to drive and navigate without human intervention. In addition to connecting to a remote system, connected vehicles also have on-board computer system that use peripheral sensors like LiDAR sensors, imaging cameras, and proximity sensors to identify and react to traffic and road conditions ahead of the path of their movement and in the proximity around their location. Remote systems provide navigational and traffic data based on the data collected from drivers' mobile phones and, sometimes, from systems embedded within the vehicle's on-board computer systems. Such systems provide the density of traffic ahead of the path of vehicle's movement, so the remote system can recommend the quickest path to the destination. Often times, traffic density is depicted in color codes (red for heavy traffic, yellow for moderate traffic, and green for light traffic) on mobile applications. There are also remote systems that gather inputs using crowdsourcing, that is, information provided voluntarily by drivers. Crowdsourcing helps gather and disseminate information to connected vehicles and drivers, which cannot be easily gathered by machines and sensors. For example, if a pothole appears suddenly on a particular location, drivers can report the location and the hazard using their mobile phones or computers and a mobile application that assists with reporting such issues. That information, in turn, is shared with other drivers traversing on that route. Using their phones, many drivers also report accidents that cannot be detected by machines unless local authorities or news media share them online, which then gets disseminated through remote systems assisting connected vehicles and drivers. Some transportation authorities and related entities have also started installing computer vision cameras that can detect accidents based on the patterns of movement of pixels captured by the camera. In these ways, connected vehicles can formulate the most effective route or path to the destination by gathering and processing data from navigational systems, information on traffic density, crowdsourced data, peripheral sensors and vehicle on-board computer systems.

In addition to the data on traffic and road conditions available from aforementioned systems and sources, further intelligent traffic data can be provided by deploying stationary sensors on roads and areas around the roads. Such sensors can be enabled by using technologies like LiDAR, imaging cameras, and thermal cameras. The main purpose of this approach is to gather data on road and various environmental conditions of the road, so connected vehicles and drivers have access to timely and accurate data to further assist with traffic navigation, driving directions, and avoidance of road hazards. This data can also be used by municipalities and enterprises, which will be explained later in this application. Each sensor can be installed and configured in various ways to collect all possible types of data from the road. The comprehensive set of data provides options and variables remote systems can use to create machine-generated recommendations for connected vehicles. Machine data gathered by each sensor can be processed to extract traffic patterns and make predictions based on those patterns, which this application claims to be the unique system and method to gather and share that data. Such patterns and predictions can then be made available to connected vehicles as an artificial intelligence to navigate autonomously on the road surface and the area above the road surface that may be used by flying drones and other machines. Furthermore, multiple sensors can be integrated by the remote system to create a transportation network system. The primary goal of this transportation network system is to gather and transmit all types of intelligence from roads to connected vehicles.

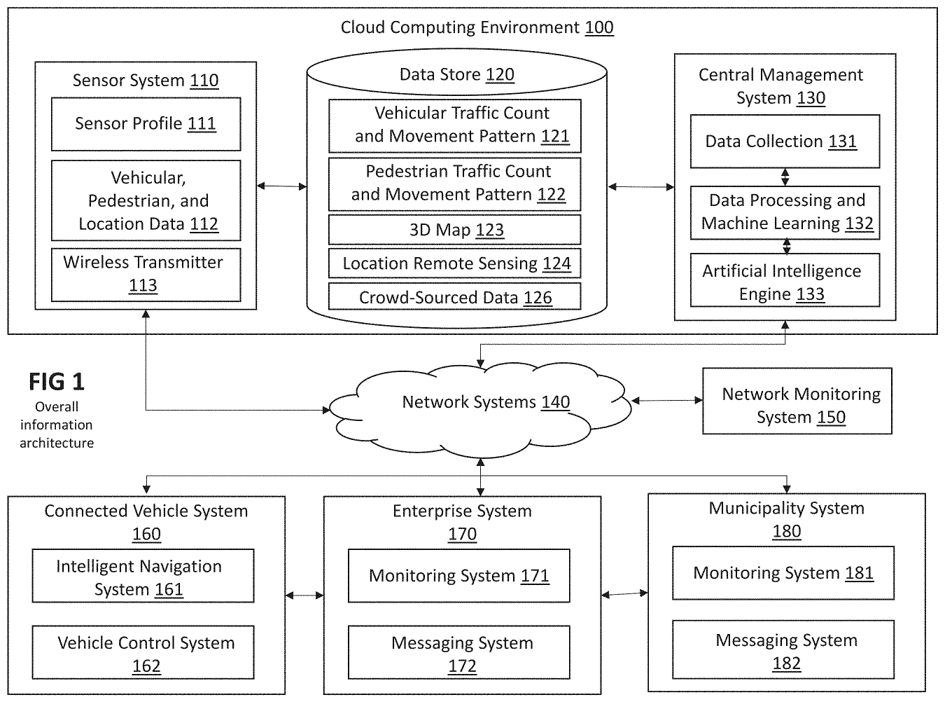

The remote system, which will be referred to as the Cloud Computing Environment 100 in FIG. 1 constitutes three major components: The Sensor System 110, Data Store 120, and Central Management System 130. The main purpose of these components is to enable a computing system that can receive data from traffic, road, and environmental sensors, store that data in a secure remote system, and, finally, process that data to provide information and intelligence to connected vehicles. The Artificial Intelligence Engine 133 is the main system that outputs this information and intelligence to connected vehicles, municipalities, and enterprises.

First and foremost, sensors 110 are the primary components of this system. This disclosure is not intended to propose a new design or architecture of sensors; Sensors are described herein to explain how they can be utilized. At a high level, sensors for this purpose are electronic equipment that can detect objects in its vicinity or proximity using technologies like Light Detection and Ranging (LiDAR), proximity sensing, and video camera feeds. Sensors can be manufactured with different configurations, so as to allow them to be purposed in a more granular way. For example, some camera sensors may implement a system by which the video feed is streamed securely over wireless or wired connection to a municipality or enterprise system. Consequently, that video feed is then processed by the remote server to identify stationary and mobile objects. Camera sensors may also be development in a way to process the video feed and images locally inside the camera system and only critical data is transmitted over wireless or wired connection to a remote system. The ability to process video and images and to draw information and intelligence from those video and images is known as computer vision.

Sensors for this purpose can be of two types that are depicted as Sensor Profile 111: Stationary or affixed sensors that are mounted on fixtures on roads, such as traffic poles, light poles, and on buildings. They collect data from their periphery based on their coverage range. Temporary sensors can be used to gather road data on a one-time or recurring basis. For example, a LiDAR camera may be mounted on a moving vehicle and it can scan the road as the vehicle moves. Data collected from its scanner can be stored in a local or remote system in a format readable by machines and computers.

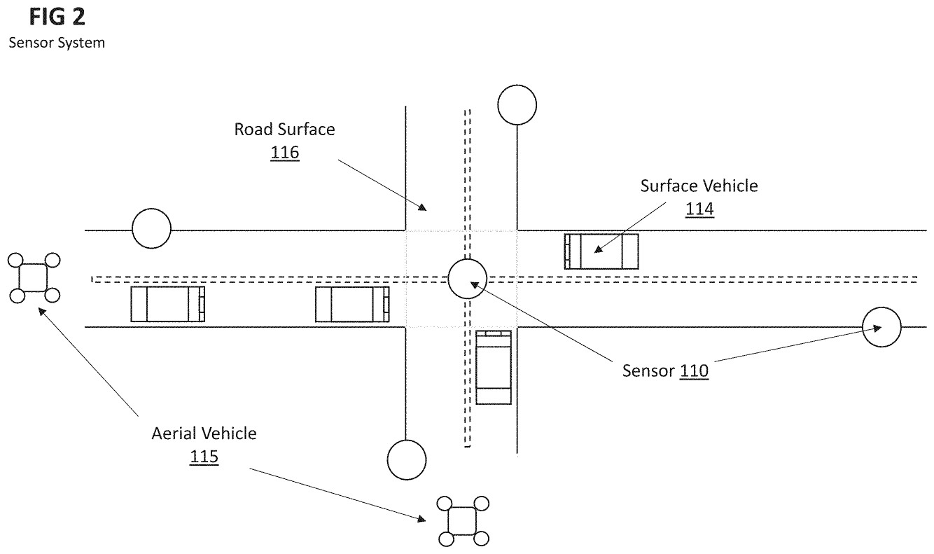

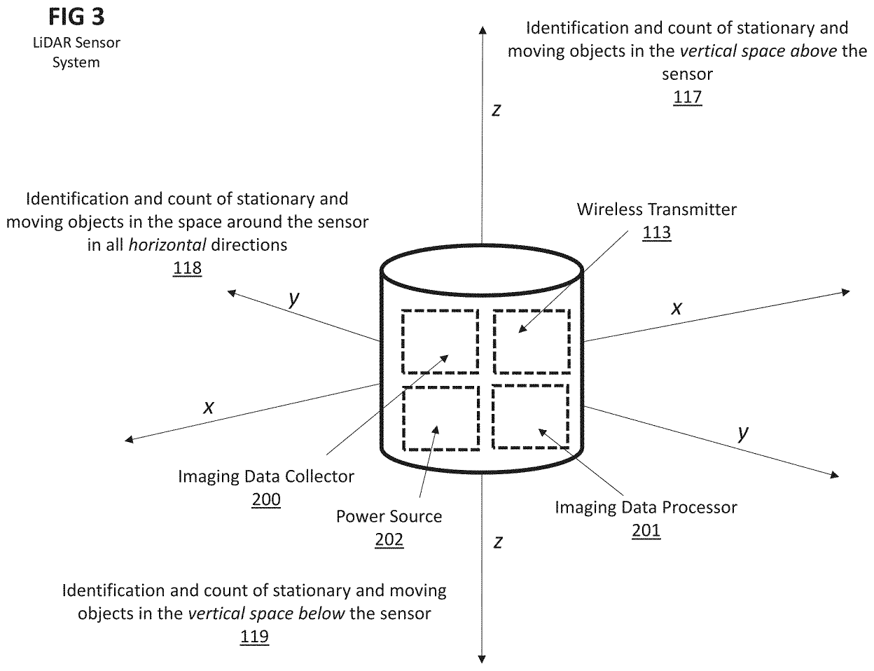

When mounting a stationary LiDAR sensor like shown in FIG. 3, light photons can be shot at in multiple directions 118 around the sensor, but they can also be configured to target certain areas of its periphery, such as the road surface FIG. 2, 116, road intersections, or any relevant landmark of the road that may provide vehicular and pedestrian traffic data. Such LiDAR sensors can also be arranged and mounted in such a way that one LiDAR sensor is dedicated to identifying traffic data for one stretch of the road, as shown in FIG. 2. Furthermore, LiDAR sensors can be targeted to detect traffic on the road surface 116 and, that is, to identify surface vehicles 114. Each sensor can also be configured to send light photons in the vertical space above the sensor FIG. 3, 117, or the vertical space below the sensor 119. The reason for scanning the vertical space above the sensor 117 or the vertical space below the sensor is to identify aerial vehicles 115 that may fly above or below the sensor. For example, delivery drones may fly above or below the sensor mounted on traffic poles.

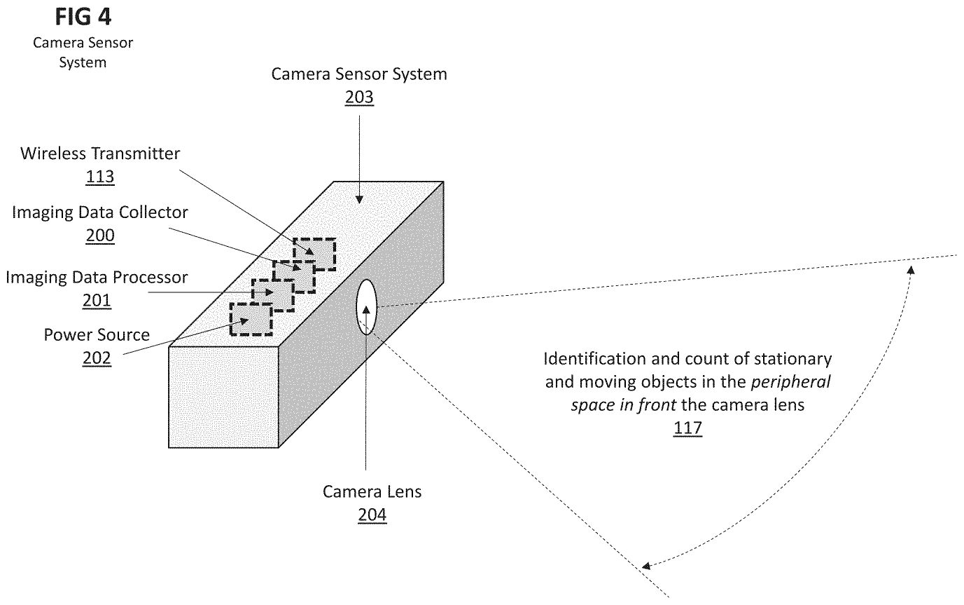

Stationary camera sensor FIG. 4 may also be mounted on road fixtures, with its lens pointed at a certain direction of its periphery 117 to capture the imaging of the road and its adjacent areas where vehicular and pedestrian traffic can be identified. Imaging from the camera sensor can be used to identify stationary and mobile objects using Computer Vision algorithms. Images can be collected and processed locally in the camera module 200. Such a camera may also include imaging data processor 201 to identify objects using Computer Vision algorithms. Images can also be sent to remote system using wireless transmitter 113, such as but not limited to LoRA/ZigBee/Z-Wave/3G/4G/5G wireless radio modules, or Ethernet wireline connection.

In order to operate, both LiDAR FIG. 3 and camera FIG. 4 sensors will require power source 202 with direct or alternating current.

Vehicular, pedestrian, and location data 112 identified and collected from the Sensor System 110 will be sent to the Data Store 120 in the remote Cloud Computing Environment 100. Sensors will send vehicular traffic count and movement pattern data 121 and pedestrian traffic count and movement pattern data 122.

Vehicular count and movement pattern data 121 can be further broken down as follows: Total count of all vehicles present in a certain radius of the sensor at any given time; Relative rate of turn of vehicles from one direction to the other, where the relative rate can be calculated based on the total number of vehicles per minute turning in a specific direction in the last minute compared to the total number of vehicles per minute turning in the same direction at the same day and time in the previous week. Relative rate of right turns can be calculated based on movement of vehicles from West to South, South to East, East to North, or North to West. Similarly, relative rate of left turns can be calculated based on movement of vehicles from West to North, South to West, East to South, and North to West. If the vehicles are not turning from one direction to the other, but moving on a straight path, then the same algorithm can be used to calculate the relative rate of movement based on the total number of vehicles per minute traveling along the straight path at a particular location in the last minute compared to the total number of vehicles per minute traveling along the same straight path at the same location at the same day and time in the previous week.

When identifying the direction of the movement of vehicles, not all roads or paths will align with geographical direction (North, West, South, East) as calculated by the compass data. For example, an intersection may have a North-West facing road with a turn to North-East facing path and another South-West facing path, while it may allow a straight path on to a South-East facing path. In such a scenario, turns will determined by compass direction, such as, 300° for the road facing North-West, 210° for the road facing South-West, 120° for the road facing South-East and 30° for the road facing North-East.

When dealing with intersections, not all intersections will be perpendicular to each other and not all intersections will be four-ways. Therefore, directional information will be calibrated and customized for each intersection or location and fed to the sensor system and, in turn, the sensor system will provide vehicular presence, relative rate of turn, and other relevant data based on the defined directional data of the location.

Similar to vehicles, pedestrian count and movement pattern 122 can be further broken down as follows: Total count of all pedestrians present in a certain radius of the sensor at any given time; Relative rate of turn of pedestrians from one direction to the other, where the relative rate can be calculated based on the total number of pedestrians per minute turning in a specific direction in the last minute compared to the total number of pedestrians per minute turning in the same direction at the same day and time in the previous week. Relative rate of right turns can be calculated based on movement of pedestrians from West to South, South to East, East to North, or North to West. Similarly, relative rate of left turns can be calculated based on movement of pedestrians from West to North, South to West, East to South, and North to West. If pedestrians are not turning from one direction to the other, but moving on a straight path, then the same algorithm can be used to calculate the relative rate of movement based on the total number of pedestrians per minute traveling along the straight path at a particular location in the last minute compared to the total number of pedestrians per minute traveling along the same straight path at the same location at the same day and time in the previous week.

When identifying the direction of the movement of pedestrians, not all roads or paths will align with geographical direction (North, West, South, East) as calculated by the compass data. For example, an intersection may have a North-West facing road with a turn to North-East facing path and another South-West facing path, while it may allow a straight path on to a South-East facing path. In such a scenario, pedestrian turns will determined by compass direction, such as, 300° for the road facing North-West, 210° for the road facing South-West, 120° for the road facing South-East and 30° for the road facing North-East.

Similar to dealing with vehicles in road intersections, for pedestrians not all intersections will be perpendicular to each other and not all intersections will be four-ways. Therefore, directional information will be calibrated and customized for each intersection or location and fed to the sensor system and, in turn, the sensor system will provide pedestrian presence, relative rate of turn, and other relevant data based on the defined directional data of the location.

For pedestrians, pathways and intersections may not always be shared with vehicles. There could be pathways dedicated to pedestrians only, and, in some cases, shared with bikes. For such pathways, sensors can be deployed and their data collected using the same approach as explained above.

The Sensor System 110, whether it is a LiDAR system FIG. 3 or a camera system FIG. 4, may use the following algorithm to identify objects as either vehicles, pedestrians, or other living or non-living objects: A pedestrian shall be identified as a human or a living being traversing at a speed of X feet per second or less, where X shall be determined at the time of system implementation. The reason for not specifying the speed in this application is because it is likely that a population in one location may walk slower or faster in average compared to another population in another location.

An object that is up to X feet in horizontal or vertical length and traversing at X feet per time interval shall be identified as a bike or slow-moving vehicle. An object that is longer than X feet and traversing at more than X distance per time interval shall be identified as vehicles. An object may also be identified as vehicle or pedestrian based on certain imaging profiles that could be gathered with imaging cameras. Imaging using Computer Vision can further help identify living or non-living objects and it may also identify animals distinctly as dogs, cats, deers, horses, etc. The Data Store 120 may store a database of images of vehicles and living beings that can be matched against the data collected by camera sensors and this is to identify the moving object.

For a given location containing static objects, such as trees, light or traffic poles, buildings, or other physical objects, when a new object is identified by the sensor at that location, then that new object shall be determined as potential topographical obstruction, new construction, or potential hazard. That new object shall be alerted to the Central Management System 130, which may lead to automated or manual processes to identify that new object and record it in the Data Store 120.

Sensors may also identify environmental particulates like water, water vapor or moisture, and other elemental particulates like carbon dioxide, carbon monoxide, etc. Any change in particulate information, such as the presence of or lack of certain particulates or the change of level of particulates, shall be reported as change in environmental condition. Furthermore, particulates shall also be identified in its liquid, vapour, and solid states, especially that of water. Sensor System 110 may also embed rainfall gauge that can distinctly identify rainwater. Sensor System 110 may also embed particulate sensors like CO2 or CO monitors to identify the given particulates.

Sensor System 110 may also identify permanently situated topographical objects. Sensor System 110 may store a 360 view of a particular geographical location, available in imaging format (video format like MPEG4 or picture format like PNG).

Sensor System 110 shall also store the data on the elevation of the sensor placement at the given location relative to the sea level. It can also store geographical location identified by latitude and longitude. It may also store the proximity range of its sensing capability in its periphery and vertical space above and below its location.

The Data Store 120 shall also store a three-dimensional map of the road using a temporary sensor with a one-time or recurring imaging of the road. The main purpose of a three-dimensional mapping is to scan the topographical makeup of the road and its surroundings, including fixed landmarks and fixtures, such as light poles, buildings, flora, overpass bridges and crosswalks, wires or poles extending horizontally across a road and various other objects that may be affixed to the road and its surroundings. This data may be overlaid with real time data gathered by LiDAR sensor FIG. 3 or camera sensor FIG. 4 to identify any change to the fixed objects on the road. For example, the temporary sensor can gather and store the surface map as a permanent imaging file that may remain unchanged until a pothole appears on the road. The LiDAR system FIG. 3 or the camera system FIG. 4 can then identify the pothole by comparing the present and historical static 3D data. This comparison may be processed locally within the sensor system 110, or the data can be analyzed by the Central Management System 130. When a connected vehicle approaches the location of the pothole, it can be supplied with the real time data on the hazard created by the pothole, including the exact location of that hazard that be identified to the level of geographical latitude and longitude. The method of this data flow will be later explained in the section described for the Artificial Intelligence Engine 133 that will be responsible for sharing any dynamic change topographical and other types of data.

The Data Store 120 can also store three-dimensional mapping of the area beneath 124 the road surface 125. Such imaging data can be scanned at a one-time or recurring basis by a temporary sensor using Ground Penetrating Radiation or GPR technology. GPR sensors scan the area beneath the surface of soil, asphalt, concrete, wood and other hard surfaces by sending electromagnetic radiation and detecting the deflected signals from objects below the surface, such as utility pipelines, underground wiring, sewage lines, etc. In the future, autonomous vehicles may be used to conduct maintenance of underground utility lines and underground objects using robotics and the three-dimensional mapping of the area beneath the road surface 124 will help such vehicles to perform their robotic tasks.

The Central Management System 130 is the remote Cloud system that collects data 131 from the Sensor System 110 for the purpose of machine learning 132. Depending on the efficacy of systems developed by this application, it is also likely that data collection 131 for the purpose of machine learning may reside in the Data Store 120. Data and pattern of data collected from vehicular traffic count and movement 121 and pedestrian traffic count and movement 122 are constantly processed and reviewed by the Data Processing and Machine Learning 132 module in the Central Management System 130 to identify patterns of traffic count and movement between multiple sensors and locations along a route of the traffic. The main driver of this machine learning is pattern analysis between multiple sensors and data generated by those sensors and also the ability to identify the pattern along a longer stretch of the road, rather than just analyzing the pattern in one specific location of the route.

Traffic patterns identified by the Data Processing and Machine Learning 132 module will be used by the Artificial Intelligence Engine 133 module to derive recommendations to be sent to connected vehicles 114 and 115. Recommendations shall include but not limited to the following information: 1. Average speed of vehicular and pedestrian traffic at a specific location of the route, or along an X mile or kilometer stretch of the route; 2. Any sudden change in average speed of vehicular or pedestrian traffic along an X mile or kilometer stretch of the road, with probable root cause data, if available. For example, a traffic stop enforced by the traffic police may result in a sudden change in the average speed of vehicular traffic. For pedestrian traffic, a street performance may also result in a sudden change in the average speed of pedestrian traffic; 3. Recommendation to proceed along the route ahead of the movement of the vehicular or pedestrian traffic based on the density of vehicular or pedestrian traffic, their average speed, and their rate of turns in all possible directions. For example, if the relative rate of turn of vehicular traffic at a particular location or intersection and in certain direction is higher than X %, then the connected vehicle can be recommended with a caution to prepare for traffic slowdown, pursue an alternative path, if one is available ahead of the movement of the vehicle, or to caution to stop or turn around if the rate of turn is higher than Y %; 4. Recommendation to proceed with caution if the density of pedestrians at a particular location or intersection is unusually lower or higher than normal for a given time of the day; 5. Recommendation to proceed with caution or at slow speed if the total count of pedestrian crossing the road at a particular location or intersection is unusually higher than normal for a given time of the day; 6. Recommendation to proceed with caution or at slow speed if there is any change in the topographical makeup of a location along the route ahead. The Artificial Intelligence Engine 133 may overlay the persisted three-dimensional data with the real time data from the LiDAR or camera sensor for a particular location of the road to determine whether there is any change in the topographical makeup of that location. For example, a pothole may appear after a storm, or objects may fall and obstruct the area on and above the road surface after a storm; 7. Recommendation to proceed with caution with the windows rolled up if there is identification of unusual moisture or particulate at a particular location of the route. The Sensor System 110 may pick up the presence of moisture or particulate and determine that it may not be healthy for vehicle driver and passengers. If a pedestrian is consuming this data using a utility application on his or her mobile phone, then the Artificial Intelligence Engine 133 will also caution him or her to take necessary precaution. These are some but not all permutations of the recommendations created by the Artificial Intelligence Engine 133, which is by coalescing data gathered from the Sensor System 110 and deriving recommendations based on pre-defined algorithms. Over time, the Artificial Intelligence Engine 133 may also include Machine Learning algorithms to extract new variables that may be identified from patterns drawn from pre-defined variables and observations, which may also lead to new algorithms.

FIG. 4 depicts the data flow supported by the Artificial Intelligence Engine 133: First, it retrieves from the Sensor System 110 vehicular and pedestrian data for a given location 134. It will then identify the density of traffic, average speed of vehicular and pedestrian traffic 135, the rate of turn of vehicles and pedestrians in all possible directions 136, and any change in nearby environmental and topographical conditions 137. The Artificial Intelligence Engine 133 may also retrieve from 3D Map 124 and Location Remote Sensing 125 data stores and coalesce that data with real time vehicle and pedestrian data. The Artificial Intelligence Engine 133 may also receive input from the Municipality System 180 with specific information or instruction 138: For example, a municipality may not allow a certain stretch of a road for vehicular traffic at a certain date and time and this is to allow a local parade or performance to pass through during that date and time. This information will be consumed by the Artificial Intelligence Engine 133, which in turn will notify external entities like the Connected Vehicle System 160 and the Enterprise System 170 about the unavailability of the specific stretch of the road specified by the Municipality System 180. The Artificial Intelligence Engine 133 may also consume Crowd-Sourced Data 126 that is voluntarily shared by drivers and pedestrians as they travel along the path to their destinations. Once the Artificial Intelligence Engine 133 has identified and consumed all relevant data and information, then it will create navigational and directional recommendations 139 and share those recommendations 140 to the Connected Vehicle System 160, the Enterprise System 170, and the Municipality System 180. This sharing method may be accomplished through publish-subscribe mechanism, by which the subscribing systems, such as connected vehicles, municipality systems, and enterprise systems, can stay abreast of real time information made available by the Artificial Intelligence Engine 133. The subscribing systems (Connected Vehicle System 160, Municipality System 170, Enterprise System 180) may also provide feedback to the Artificial Intelligence Engine 133, acknowledgement of data receipt, or error messages in data transmission.

The Central Management System 130 may also share the raw data from the Data Store 120 and its components to external entities like the Enterprise System 170, the Municipality System 180 and other third party entities through an Application Programming Interface (API). Some entities may wish to develop their own artificial intelligence engine and not use the system 133 proposed by this application.

Network Systems 140 depict various wired and wireless connections that may be used between multiple systems. The Sensor System 110 may connect one sensor in one location to another sensor in another location with close proximity using short-range wireless connections, such as LoRA, NBIoT, Bluetooth, WiFi, ZigBee, or Z-Wave. Connection between two sensors at close proximity may be required as a failover to long-range wireless connections like 3G, 4G, or 5G. Multiple sensors at close proximity may be connected with one another with short-range wireless connections to form a daisy chain of sensors to collect and store data with a sensor or multiple systems. In such a scenario, surface vehicle 114 or aerial vehicle 115 may also support a short-range wireless connection to connect to the local area network and operate locally within a short area if there is failure of long-range wireless connection.

The Sensor System 110 may also use long-range wireless connections, such as 3G, 4G, or 5G and also wired connection using Ethernet or direct Fiber lines.

The Network Systems 140 will be supported by a Network Monitoring System 150 to ensure there's no failure of a long-range or short-range wireless or wired connection and, if there is a failure of one connection, then the Network Monitoring System 150 will alert the Network Systems to default to the network type available at the given time. This type of monitoring will be required to guarantee 100% availability of network for connected vehicles.

The Artificial Intelligence Engine 133 is primarily responsible for sending dynamic and intelligent data gathered from the Sensor System 110 through an Application Programming Interface (API) to various external systems. This API is managed by the Central Management System 130. The Artificial Intelligence Engine 133 may also send static data from the Sensor System 110, such as the system availability of a certain Sensor Profile 111 at a specific location or intersection of the road. For example, a LiDAR sensor may experience a power or system outage at a certain location and the Artificial Intelligence Engine 133 may share Boolean data YES or NO to system availability to connected vehicles approaching that location or intersection. For the most part, however, the Artificial Intelligent Engine 133 will be responsible for sending dynamic and intelligence data based on the processing of real time and non-real time variables explained in prior sections of this document.

Three main external systems are envisioned to take advantage of the data made available by the Artificial Intelligent Engine 133: The Connected Vehicle System 160 that is comprised of computer systems embedded within the vehicle, which interacts with the Central Management System 130 API and it can also interact with its own remote Cloud systems for various other purposes that are outside the purpose of this disclosure. The Enterprise System 170 that could be managed by various entities affiliated with the Connected Vehicle System 160, such as vehicle manufacturers, vehicle original equipment manufacturers (OEM), or entities that provider telematics systems providers. The Municipality System 180 that is managed by local, regional, or national government entities. For various purposes, the Connected Vehicle System 160, the Enterprise System 170, and the Municipality System 180 may interact with each other through Application Programming Interfaces (API) managed by their respective systems outside the jurisdiction of the Central Management System 130.

The main component of the Connected Vehicle System 160 is envisaged to be resident in the connected vehicle itself, with connection to the Central Management System 130 through Network Systems 140. The Connected Vehicle System 160 may also connect with its respective remote Cloud system managed by the vehicle manufacturer, vehicle OEMs or various other system providers affiliated the vehicle manufacturer. The Connected Vehicle System 160 may also connect with the Enterprise System 170, also through Network Systems 140. As mentioned earlier, the Enterprise System 170 could be managed by the vehicle manufacturer and vehicle OEMs. As the connected surface vehicle 114 or the connected vehicle 115 moves along the path of its route, its corresponding Connected Vehicle System 160 will identify the geo positioning location data of its location. This location identification may be accomplished by the Intelligent Navigation System 161 component that may have the GPS capability. The system 160 will then request for transportation network data for the given location and current time from the Artificial Intelligence Engine 133. Upon getting the location and current time data from the Connected Vehicle System 160, the Artificial Intelligence Engine 133 will send the appropriate recommendations to the former system 160. Upon receiving the recommendations from the Artificial Intelligence Engine 133, the Connected Vehicle System 160 will then send corresponding inputs to the Vehicle Control System 166 that is responsible for controlling the movement and operations of the vehicle. The Connected Vehicle System 160 may also supply feedback to the Artificial Intelligence Engine based on the recommendations and the outcome of those recommendations maneuvered by the Vehicle Control System 166. For example, the Artificial Intelligence Engine 133 may recommend the connected vehicle to maintain a steady speed of 35 MPH or 56 Km/H, however, the onboard LiDAR system integrated with the Connected Vehicle System 160 may detect the traffic in the front traveling at 30 MPH or 48 Km/H. In such a scenario, the Artificial Intelligence Engine 133 will refine its recommendations to 30 MPH, thereby, not forcing the connected vehicle to crash into the traffic in the front. In this way, the Connected Vehicle System 160 can help improve the quality of recommendations supplied by the Artificial Intelligence Engine 133.

The Enterprise System 170 will poll the Artificial Intelligence Engine 133 for recommendations for one or more than one location at the same time. The entity or entities associated with the Enterprise System 170 may be interested to learn about the traffic condition or any topographical changes in a certain location for various reasons. For example, a vehicle fleet management company may use the Enterprise System 170 to monitor the traffic and topographical conditions of certain areas where the majority of its fleet vehicles operate. By identifying the location 173 of the desired areas, the Enterprise System 170 will also request for the intelligent transportation data from the Artificial Intelligence Engine 133, process that recommendations 175, and send relevant information to its sub-systems 176. Such sub-systems may route those recommendations in various ways, for example, notify the Connected Vehicle System 160 of its fleet in a certain area to delay the delivery of goods by X minutes or hours, or cancel the delivery altogether in that area. The sub-systems may also notify other components or human operators of the Enterprise System 170 with appropriates notifications or recommendations (177). For example, a storm damage of certain areas of a town may result in the postponement of delivery of goods in those areas, in which case the human operators of that Enterprise System may need to be notified of the delay. This event may also need to be notified to customers or end-users (177). Any input from the Enterprise System 170 and its sub-systems and methods and procedures will then be sent as feedback to the Artificial Intelligence Engine 133. For example, the Enterprise System 170 may notify the Artificial Intelligence Engine 133 of the delay of delivery by its fleet by a day, in which case the Artificial Intelligence Engine 133 can anticipate a surge of the number of delivery vehicles after X hours.

Similar to the Enterprise System 170, the Municipality System 180 will poll the Artificial Intelligence Engine 133 for recommendations for one or more than one location at the same time. The entity or entities associated with the Municipality System 180 may be interested to learn about the traffic condition or any topographical changes in a certain location for various reasons. For example, the municipality using the Municipality System 180 may prefer to monitor the traffic and topographical conditions of one or all parts of the town where it deploys its utility vehicles, such as garbage collection and disposal trucks. By identifying the location 183 of the desired areas, the Municipality System 180 will request for and retrieve 184 the intelligent transportation data from the Artificial Intelligence Engine 133, process that recommendations 185, and send relevant information to its sub-systems 186. Such sub-systems may route those recommendations in various ways, for example, notify the Connected Vehicle System 160 used by those connected utility vehicles to delay respective operations, such as garbage collection, by X minutes or hours. The sub-systems may also notify other components or human operators of the Municipality System 180 with appropriates notifications or recommendations (187). For example, a storm damage of certain areas of a town may result in the postponement of service in those areas, in which case the human operators of that Municipality System may need to be notified of the delay. This event may also need to be notified to customers or end-users (187) connected to the municipality system. Any input from the Municipality System 180 and its sub-systems and methods and procedures will then be sent as feedback to the Artificial Intelligence Engine 133. For example, the Municipality System 180 may notify the Artificial Intelligence Engine 133 of the delay of delivery by its service by a day, in which case the Artificial Intelligence Engine 133 can anticipate a surge of the number of delivery vehicles after X hours.

The disclosure and its embodiments described above encapsulate the primary systems and methods to enable a transportation network for connected and autonomous vehicles. It may be possible to create variations and modifications of the above disclosure and embodiments without deviating substantially from the main theme and the principle of the disclosure.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A transportation network system that provides machine intelligence relating to at least one road and a periphery of the at least one road, the system comprising:
a plurality of sensors configured to identify static and moving objects on the at least one road, spatial dimensions of the objects with respect to the at least one road, and an environment around the objects, the sensors being configured to translate and store the identified objects, spatial dimensions, and environment as machine readable data;
a plurality of communication devices and transmitters configured transmit the machine readable data between the plurality of sensors and to remote computer cloud systems; and
a computer cloud system configured to receive the machine readable data from the plurality of communication devices and to store the machine readable data, the computer cloud system being configured to create machine intelligence based on the machine readable data, the computer cloud system comprising an application programming interface configured to share the machine readable data and the machine intelligence to at least one of a connected vehicle, a municipality, or an enterprise.

2. The transportation network system of claim 1, wherein the computer cloud system further comprises a database configured to store historical and current data on vehicular and pedestrian traffic counts and movement patterns and a three-dimensional map of the road and a periphery of the road.

3. The transportation network system of claim 1, wherein the plurality of sensors are configured to identify static and moving objects in air above a surface of the road.

4. A method of providing an intelligent transportation network of at least one road, comprising:
aggregating data on a presence and directional movement of one or more object, a density and speed of the one or more objects, and a description of an environment around the one or more objects, so as to provide aggregated data;
using the aggregated data to derive patterns to describe historical behaviors, density, speed, and characteristics of the one or more objects and the space and the environment around the one or more objects;
aggregating, analyzing, and storing historical data of cardinal direction movement of the one or more objects from one direction to an other direction; and
creating at least one prediction comprising probabilistic behaviors and characteristics of the one or more objects and the environment around the one or more objects.

5. The method of claim 4, further comprising:
sharing, using an application programming interface, at least one of the historical data or the at least one prediction with at least one of a connected vehicle system, a municipality, or an enterprise system.

6. The method of claim 5, further comprising:
receiving feedback from the connected vehicle system, the municipality, or the enterprise system regarding the data, the feedback comprising at least one of an acknowledgement of receipt of the data by the connected vehicle system, the municipality, or the enterprise system, or a validation of the data received by the connected vehicle system, the municipality, or the enterprise system.

7. The method of claim 5, further comprising:
providing, to the connected vehicle system, the municipality, or the enterprise system, access to at least one of the historical data or the at least one prediction.

8. The method of claim 5, wherein the sharing comprises sharing with the municipality, and
wherein the method further comprises using an artificial intelligence engine to consolidate feedback from the municipality into recommendations and sending the recommendations to at least one of the municipality, the connected vehicle system, or the enterprise system.

9. The method of claim 4, further comprising:
creating an intelligent communication network comprising at least one of communications transmitters associated with the at least one road, physical infrastructures around the at least one road, connected vehicles operating on the at least one road, or smartphones or standalone devices used by pedestrians traveling along the at least one road; and
relaying data collected by the intelligent communication network to one or more connected vehicles.

10. The method of claim 9, wherein the intelligent communication network comprises communications transmitters, and
wherein the method further comprises dynamically relaying data communication between the communication transmitters

11. The method of claim 9, further comprising:
identifying along the at least one road a rate of directional turn of vehicular or pedestrian traffic in a particular location or intersection and at a given time and from one direction to an other direction;
using an historical rate of directional turns of vehicular or pedestrian traffic at the particular location or intersection to derive a pattern of the rate of directional turns of vehicular or pedestrian traffic at the particular location or intersection at the given time; and
using an historical pattern of the rate of directional turns of vehicular or pedestrian traffic to create a prediction of the rate of directional turns of traffic at a future date and time.

12. The method of claim 9, further comprising:
identifying an average speed of vehicular or pedestrian traffic along the at least one road in a particular location and at a given time; and
using an historical speed of vehicular or pedestrian traffic in the particular location to predict a speed of traffic at the particular location at a future time.

13. The method of claim 9, further comprising:
identifying changes in topographical conditions along the at least one road.

14. An artificial intelligence engine for a transportation network that includes one or more data sources associated with at least one road, the data sources including at least one of one or more objects traveling along the at least one road, the artificial intelligence engine comprising:
a sensor system configured to receive data from the one or more data sources, the data comprising at least one of historical behaviors of the one or more data sources, historical density and speed of the one or more data sources within the transportation network, historical characteristics of the one or more data sources, or environmental variables around the one or more data sources;
a cloud system configured to collect the data from the sensor system, the cloud system being configured to create, based on the data, at least one of historical patterns of the one or more data sources or insights relating to the presence or movement of the one or more data sources or to the environmental variables; and
a recommendation engine configured to create recommendations based on the historical patterns or insights and on the data.

15. The artificial intelligence engine of claim 14, wherein the recommendations comprise at least one of:
estimated time required to travel from one geo-location on the at least one road to an other geo-location on the at least one road,
a delay or non-delay expected from a traffic density and speed identified at a time of travel or historical data based on specific time of day or week,
a most efficient route to a destination based on expected delay or a density or speed of data sources identified at a time of travel or patterns of turns by vehicles and pedestrians in cardinal directions at specific intersections along the at least one road,
a topographical condition along the at least one road,
a spatial condition above the at least one road, or
safeguards against environmental variables identified at a particular geo-location at the time of travel.

16. The artificial intelligence engine of claim 15, wherein the environmental variables comprise an amount of particulate in air near the particular geo-location.

17. The artificial intelligence engine of claim 15, wherein the artificial intelligence engine is configured to notify a connected vehicle system, a municipality, or an enterprise system of an availability of recommendations at a specific geo-location or at a portion of the at least one road.
